(19) United States
(12) Patent Application Publication
(10) Pub. No.: US 2008/0231596 A1
(43) Pub. Date: Sep. 25, 2008

(54) KEY SHAPED POINTING DEVICE

(76) Inventors: Yung-Lung Liu, Ta Ya Shiang (TW); Cheng-Tsung Juan, Ta Ya Shiang (TW)

Correspondence Address: G. LINK CO., LTD., 3550 BELL ROAD, MINOOKA, IL, 60447, US

(21) Appl. No.: 11/687,819

(22) Filed: Mar. 19, 2007

(51) Int. Cl. G06F 3/033

(52) U.S. Cl. 345/158

(57) ABSTRACT

A key shaped pointing device adapted to mounted on a keyboard of a notebook computer, a keypad of a mobile phone, or a keyboard of a PC includes a substrate including two opposite top latches; a circuit board releasably secured to the substrate; a chip fixedly mounted on the substrate and including a light source, a photosensor, and a processor; and a casing including a transparent top window and opposite openings releasably secured to the latches. The finger as a reflection member is adapted to contact the window for creating a first optical path from the light source to the photosensor via the finger. A movement of the finger is adapted to create a second optical path. The processor is adapted to calculate a direction and a distance corresponding to the movement by comparing the second optical path with the first optical path for generating a cursor control output.

### BACKGROUND OF THE INVENTION

1. Field of Invention

The invention relates to pointing devices for cursors on display screens for personal computers, notebooks, and mobile phones, and more particularly to a pointing device shaped as a key adapted to mount on a keyboard of a personal computer (or a notebook) or a keypad of a mobile phone.

2. Description of Related Art

A trackball is typically mounted on a keyboard of a notebook computer or a keypad of a mobile phone. Further, some types of desk top computers have a trackball integrally formed with its keyboard.

Components and operating principles of a typical trackball are described in detail below. A chip mounted on a substrate is electrically connected to circuitry of a keyboard of, for example, a personal computer (PC). On the chip, there are provided a photosensor and a direction and distance calculation element. A light source (e.g., laser diode) is mounted on the substrate and is adjacent the chip. The above components and a ball are housed in a ball cage in which different colors or speckles are formed on the ball and the ball is rotatable relative to the ball cage. Light rays emitted by the light source impinge on the uneven surface of the ball and are then reflected to be received by the photosensor. Thus, rotation of the ball can be converted into a digital representation useable to move a cursor on a display screen of the PC.

However, the well known trackball suffered from a couple of disadvantages. For example, it is relatively bulky. Hence, it is not suitable to mount on a compact electronic device (e.g., a keyboard of a notebook computer or a keypad of a mobile phone). Further, its resolution is low, i.e., low sensitivity. Thus, the need for improvement still exists.

### SUMMARY OF THE INVENTION

It is therefore one object of the invention to provide a key shaped pointing device for controlling the position of a cursor on a display for a personal computer, a notebook computer, or a mobile phone, comprising a rectangular substrate including two opposite latches on a top surface; a circuit board releasably secured to the substrate; a chip fixedly mounted on the substrate and including a light source, a photosensor, and a processor; and a casing for enclosing the chip and the substrate and including a transparent top window and two opposite openings releasably secured to the latches, wherein a reflection member is adapted to contact the window for creating a first optical path from the light source to the photosensor via the reflection member, a movement of the reflection member is adapted to create a second optical path, and the processor is adapted to calculate a direction and a distance corresponding to the movement of the reflection member by comparing the second optical path with the first optical path for generating a cursor control output.

In one aspect of the invention the pointing device is mounted on a keyboard of a notebook computer, a keypad of a mobile phone, or a keyboard of a personal computer.

In another aspect of the invention the light source is a laser diode or a LED.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of key shaped pointing device according to the invention;

FIG. 2 is a sectional view of the assembled pointing device with the finger served as a reflection member for cursor moving operation;

FIG. 3 is a perspective view of the pointing device to be mounted on a key slot of a computer keyboard; and

FIG. 4 is a perspective view of the pointing device to be mounted on a key slot of a keypad of a mobile phone.

### DETAILED DESCRIPTION OF THE INVENTION

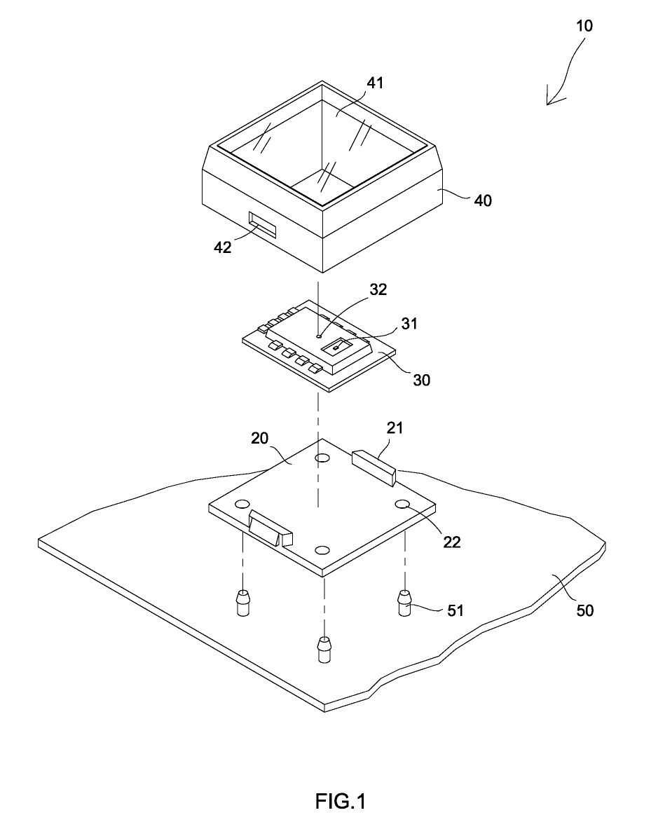

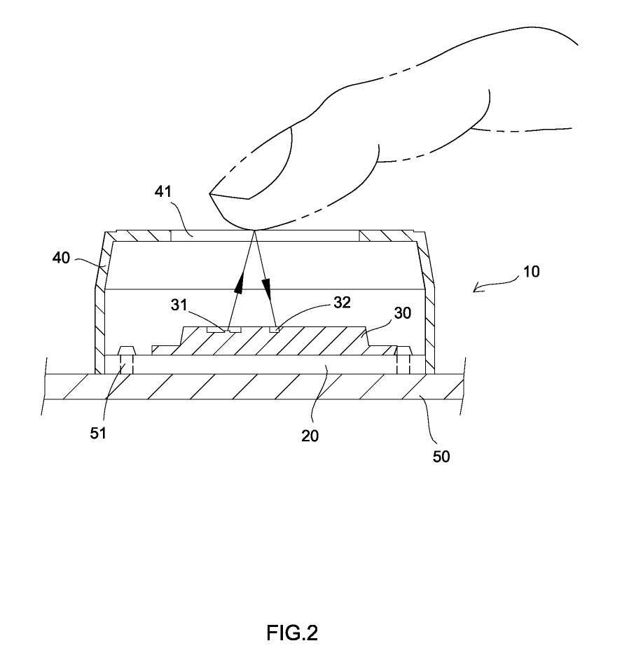

Referring to FIGS. 1 and 2, a key shaped pointing device 10 in accordance with a preferred embodiment of the invention is shown. The pointing device 10 comprises a rectangular substrate 20 including two opposite latches 21 on a top surface proximate front and rear ends, and four holes 22 at four corners respectively; and a circuit board 50 including four pegs 51 each adapted to insert through the holes 22 for fastening the substrate 20 on the circuit board 50.

The pointing device 10 further comprises a rectangular chip 30 fixedly mounted on the substrate 20. The chip 30 comprises a light source 31 provided on a top recess, a photesensor 32 provided on a center proximate the recess, and a direction and distance calculation element (not shown); and a rectangular casing 40 including a transparent top window 41 in light communication with components including the chip 30 and the substrate 20 therebelow, and front and rear openings 42 with the latches 21 securely engaged therein, i.e., the casing 40 and the substrate 20 being fastened together.

Preferably, the light source 31 is a laser diode capable of emitting laser light rays of a single color. Laser diodes are advantageous for being lightweight, low power consumption, and high efficiency.

Still preferably, the light source 31 is a LED (light-emitting diode) capable of emitting infrared light rays.

Operating principles of the pointing device of the invention are described in detail below. As shown in FIG. 2, a user may use the finger to contact the window 41 and move thereon. Alternatively, an eraser may be employed as a replacement of the finger. Light rays are emitted by the light source 31 and impinge on the uneven surface of the finger through the window 41. Next, light is reflected from the finger to be received by the photosensor 32. As a result, a first optical path is created as indicated by arrows. A second optical path is created from the light source 31 to the photosensor 32 via the finger in response to moving the finger on the window 41. The first and second optical paths are different. Hence, the direction and distance calculation element can calculate a direction and a distance corresponding to the movement of the finger by employing an algorithm. Eventually, the direction and distance are converted into a digital representation useable to move a cursor on a display screen of, for example, a PC.

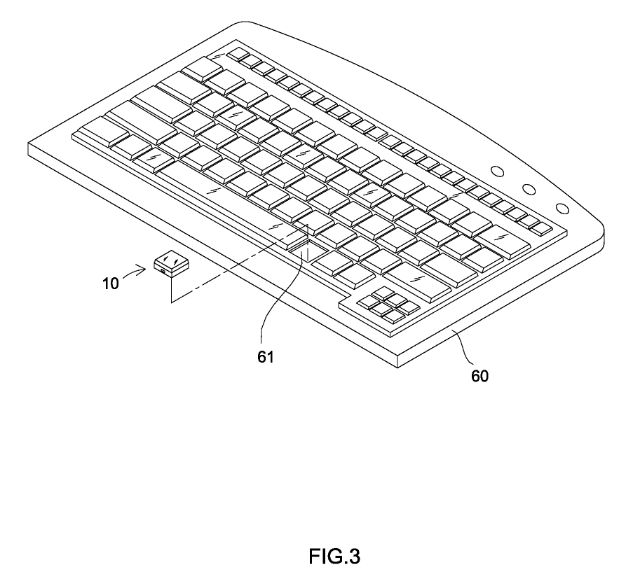

Referring to FIG. 3, in one embodiment the pointing device 10 is mounted on a key slot 61 of a computer keyboard 60.

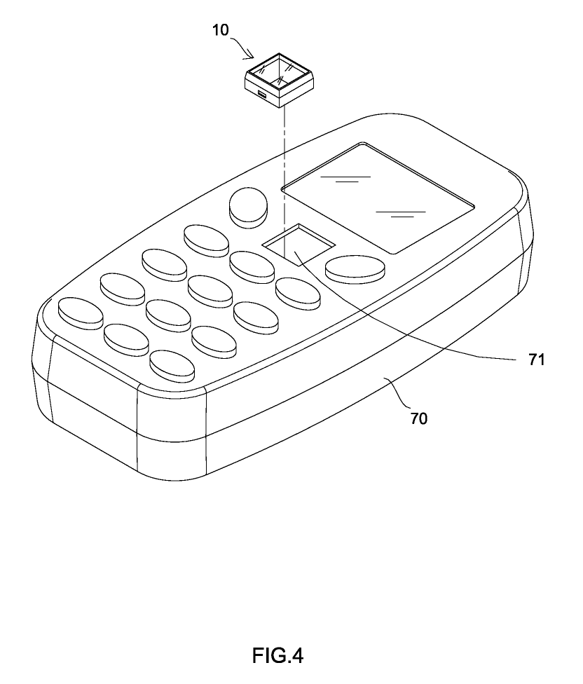

Referring to FIG. 4, in another embodiment the pointing device 10 is mounted on a key slot 71 of a keypad of a mobile phone 70.

The invention has the following advantages. It is small. Hence, it is suitable to mount on a compact electronic device (e.g., a keyboard of a notebook computer, a keypad of a mobile phone, or a keyboard of a PC. Further, its resolution is high, i.e., high sensitivity in cursor moving operation.

While the invention herein disclosed has been described by means of specific embodiments, numerous modifications and variations could be made thereto by those skilled in the art without departing from the scope and spirit of the invention set forth in the claims.

What is claimed is:

1. A pointing device for controlling the position of a cursor on a display for a personal computer, a notebook computer, or a mobile phone, comprising:
a rectangular substrate including two opposite latches on a top surface;
a circuit board releasably secured to the substrate;
a chip fixedly mounted on the substrate and including light source means, sensor means, and processing means; and
a casing for enclosing the chip and the substrate and including a transparent top window and two opposite openings releasably secured to the latches,
wherein reflection means is adapted to contact the window for creating a first optical path from the light source means to the sensor means via the reflection means, a movement of the reflection means is adapted to create a second optical path from the light source means to the sensor means via the reflection means, and the processing means is adapted to calculate a direction and a distance corresponding to the movement of the reflection means by comparing the second optical path with the first optical path for generating a cursor control output.

2. The pointing device of claim 1, wherein the pointing device is mounted as one of a plurality of keys of a keyboard of a notebook computer, a keypad of a mobile phone, or a keyboard of a personal computer.

3. The pointing device of claim 1, wherein the light source means is a laser diode.

4. The pointing device of claim 1, wherein the light source means is a LED (light-emitting diode).

5. The pointing device of claim 1, wherein the reflection means is a finger.

6. The pointing device of claim 1, wherein the reflection means is an eraser.
